(19) United States
(12) Patent Application Publication
(10) Pub. No.: US 2009/0111948 A1
(43) Pub. Date: Apr. 30, 2009

(54) Compositions comprising polyimide and hydrophobic epoxy and phenolic resins, and methods relating thereto

(76) Inventors: Thomas Eugene Dueber, Wilmington, DE (US); Nyrissa S. Rogado, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/977,563

(22) Filed: Oct. 25, 2007

(51) Int. Cl. C08L 63/00

(52) U.S. Cl. 525/396

(57) ABSTRACT

Water absorption resistant compositions of the present disclosure, e.g., pastes (or solutions), are well suited for electronic screen-printable materials and electronic components. The composition of the present disclosure may optionally contain thermal crosslinking agents, adhesion promoters, and other inorganic fillers. The composition of the present disclosure can have a glass transition temperature greater than 250° C. and a water absorption factor of less than 2%, and a positive solubility measurement.

### FIELD OF DISCLOSURE

The present disclosure relates generally to compositions having a polyimide component, a hydrophobic epoxy component, a hydrophobic phenolic resin and an organic solvent. More specifically, the compositions of the present invention provide advantageous properties in resistor or similar-type electronics applications.

### BACKGROUND OF DISCLOSURE

U.S. Pat. No. 5,980,785 to Xi, et al. broadly teaches compositions useful in electronic applications created by screen-printing pastes, followed by heat and/or chemical reaction induced solidification. However as the electronics industry advances, many such pastes must be increasingly resistant to water sorption in high humidity, high temperature environments.

Furthermore, when a resistor film is screen printed and solidified upon a conductive substrate, a reliable and stable bond must be formed at the interface (between the conductive substrate and the resistor film). If not, resistor properties can tend to drift or otherwise become problematic. If a traditional PTF resistor film is bonded directly to a copper trace, the resistance properties will generally drift, due to instability and unreliability at the resistor/conductor interface. Consequently, before conventional resistor films are applied to a copper trace, the copper trace is typically plated with silver (e.g., the copper trace is first exposed to a silver immersion plating process), since silver at the interface (between the resistor film and the copper trace) will generally provide a more stable and reliable interface, resulting in improved resistor performance. However, silver plating can be expensive and can add to the overall complexity of the manufacturing process. A need therefore also exists for resistor film compositions capable of being applied directly to copper traces with improved interface reliability and stability, relative to known resistor film compositions.

### DETAILED DESCRIPTION OF THE PREFERRED EMBODIMENT(S)

The present disclosure is directed to compositions comprising a polyimide moiety, a hydrophobic epoxy moiety, a hydrophobic phenolic resin and an organic solvent. The compositions of the present invention have advantageous interface reliability and stability, as well as, low “thermal coefficient of resistance”, “resistance change with temperature” and “resistance change with lamination” when used for resistor type applications.

The term “paste” herein denotes a solution or suspension that is capable of being used for screen printing. The viscosity is typically in the range of 60 to 110 Pascal seconds (PaS) when measured at 10 RPM.

The term “screen printing” herein denotes a thick film process in which a paste or ink is squeezed with the use of a squeegee through open areas of a screen and transferred to the surface of a substrate. “Screen printing” is meant to include stencil printing or any other similar-type technique.

The term “water absorption factor” herein denotes the equilibrium amount of water absorption at room temperature that a material will absorb which can be assessed with standard test methods.

The term “positive solubility measurement” herein denotes a test performance where the polymer in a 10% solids composition remains soluble when subjected to a relative humidity of about 85% for a period greater than or equal to eight (8) hours at room temperature.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only to those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a”, “an” or “the” are employed to describe elements and components of the invention. This is done merely for convenience and to give a general sense of the invention. This description should be read to include one or at least one and the singular also includes the plural unless it is obvious that it is meant otherwise.

Polyimides are generally prepared from a dianhydride, or the corresponding diacid-diester, diacid halide ester, or tetra-carboxylic acid derivative of the dianhydride, and a diamine. For purposes of the present disclosure, particular dianhydrides and a particular range of particular diamines were discovered to be useful in the preparation of a water-resistant polyimide.

The polyimide of the present disclosure can be represented by the general formula,

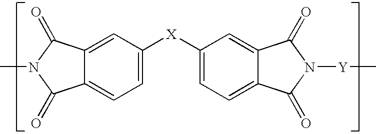

where X can be equal to SO₂, C(CF₃)₂, C(CF₃)₂ C(CF₃)phenyl, C(CF₃)CF₂CF₃, C(CF₂CF₃)phenyl (and combinations thereof); and where Y is derived from a diamine component comprising a phenolic-containing diamine. If less than 2 mole percent of the total diamine component comprises phenolic containing diamines, the polyimide formed may not be capable of sufficiently crosslinking with the epoxy component. If more than 50 mole percent of the diamine component is a phenolic containing diamine, the polyimide may be highly susceptible to unwanted water absorption. The phenolic containing diamine in the present disclosure is present in the amount between and optionally including any two of the following numbers 2, 4, 8, 10, 12, 14, 16, 18, 20, 22, 24, 26, 28, 30, 32, 34, 36, 38, 40, 42, 44, 46, 48, 50. In some embodiments, the phenolic containing diamine is selected from the group consisting of 2,2′-bis(3-amino-4-hydroxyphenyl) hexafluoropropane (6F-AP), 3,3′-dihydroxy-4,4′-diaminobiphenyl (HAB), 2,4-diaminophenol, 2,3-diaminophenol, 3,3′-diamino-4,4′-dihydroxy-biphenyl, 2,2′-bis(3-amino-4-hydroxyphenyl)hexafluoropropane and mixtures thereof.

The remaining portion of the diamine is present in the amount between and optionally including any two of the following numbers 50, 52, 54, 56, 58, 60, 62, 64, 68, 70, 72, 74, 76, 78, 80, 82, 84, 86, 88, 90, 92, 94, 96, 98. In some embodiments, the remaining diamine component is selected from 3,4′-diaminodiphenyl ether (3,4′-ODA), 4,4′-diamino-2,2′-bis(trifluoromethyl)biphenyl (TFMB), 3,3′,5,5′-tetramethylbenzidine, 2,3,5,6-tetramethyl-1,4-phenylenediamine, 3,3′-diaminodiphenyl sulfone, 3,3′dimethylbenzidine, 3,3′-bis(trifluoromethyl)benzidine, 2,2′-bis-(p-aminophenyl)hexafluoropropane, bis(trifluoromethoxy)benzidine (TFMOB), 2,2′-bis(pentafluoroethoxy)benzidine (TFEOB), 2,2′-trifluoromethyl-4,4′-oxydianiline (OBABTF), 2-phenyl-2-trifluoromethyl-bis(p-aminophenyl)methane, 2-phenyl-2-trifluoromethyl-bis(m-aminophenyl)methane, 2,2′-bis(2-heptafluoroisopropoxy-tetrafluoroethoxy)benzidine (DFPOB), 2,2-bis(m-aminophenyl)hexafluoropropane (6-FmDA), 2,2-bis(3-amino-4-methylphenyl)hexafluoropropane, 3,6-bis(trifluoromethyl)-1,4-diaminobenzene (2TFMPDA), 1-(3,5-diaminophenyl)-2,2-bis(trifluoromethyl)-3,3,4,4,5,5,5-heptafluoropentane, 3,5-diaminobenzotrifluoride (3,5-DABTF), 3,5-diamino-5-(pentafluoroethyl)benzene, 3,5-diamino-5-(heptafluoropropyl)benzene, 2,2′-dimethylbenzidine (DMBZ), 2,2′,6,6′-tetramethylbenzidine (TMBZ), 3,6-diamino-9,9-bis(trifluoromethyl)xanthene (6FCDAM), 3,6-diamino-9-trifluoromethyl-9-phenylxanthene (3FCDAM), 3,6-diamino-9,9-diphenyl xanthene and mixtures thereof.

Polyimides of the disclosure are prepared by reacting a suitable dianhydride (or mixture of suitable dianhydrides, or the corresponding diacid-diester, diacid halide ester, or tetracarboxylic acid thereof) with one or more selected diamines. In some embodiments, the mole ratio of dianhydride component to diamine component is from 0.9 to 1.1. In some embodiments, the mole ratio of dianhydride component to diamine component is from 1.01 to 1.02. In some embodiments, end capping agents, such as phthalic anhydride, can be added to control chain length of the polyimide.

In some embodiments, dianhydrides of the present disclosure are selected from 3,3′,4,4′-diphenylsulfone tetracarboxylic dianhydride (DSDA), 2,2-bis(3,4-dicarboxyphenyl)1,1,1,3,3,3-hexafluoropropane dianhydride (6-FDA), 1-phenyl-1,1-bis(3,4-dicarboxyphenyl)-2,2,2-trifluoroethane dianhydride, 1,1,1,3,3,4,4,4-octylfluoro-2,2-bis(3,4-dicarboxyphenyl)butane dianhydride, 1-phenyl-2,2,3,3,3-pentafluoro-1,1-bis(3,4-dicarboxylphenyl)propane dianhydride, 4,4′-oxydiphthalic anhydride (ODPA), 2,2′-bis(3,4-dicarboxyphenyl)propane dianhydride, 2,2′-bis(3,4-dicarboxyphenyl)-2-phenylethane dianhydride, 2,3,6,7-tetracarboxy-9-trifluoromethyl-9-phenylxanthene dianhydride (3FCDA), 2,3,6,7-tetracarboxy-9,9-bis(trifluoromethyl)xanthene dianhydride (6FCDA), 2,3,6,7-tetracarboxy-9-methyl-9-trifluoromethylxanthene dianhydride (MTXDA), 2,3,6,7-tetracarboxy-9-phenyl-9-methylxanthene dianhydride (MPXDA), 2,3,6,7-tetracarboxy-9,9-dimethylxanthene dianhydride (NMXDA) and combinations thereof. These dianhydrides can be used alone or in combination with one another.

For a comparison of the relative amounts of the different parts of the composition of the invention, the polyimide is present at 100 parts by weight of solid, undissolved polyimide. The polyimides used in the composition will also exhibit a positive solubility measurement in an organic solvent.

In some embodiments, the polyimides can be made by thermal imidization. In some embodiments, the polyimides can be made by chemical imidization. Using a thermal method, the dianhydride can be added to a solution of the diamine in any of the following polar solvents, m-cresol, 2-pyrrolidone, N-methylpyrrolidone (NMP), N-ethylpyrrolidone, N-vinylpyrrolidone), N,N′-dimethyl-N,N′-propylene urea (DMPU), cyclohexylpyrrolidone (CHP), N,N-dimethylacetamide (DMAc), N,N-dimethylformamide (DMF) and γ-butyrolactone (BLO). The reaction temperature for preparation of the polyamic acid or polyamic acid ester is typically between 25° C. and 40° C. Alternatively, the dianhydrides were dissolved in one of these solvents, and the diamines were added to the dianhydride solution.

After the polyamic acid (or polyamic acid ester) is produced, the temperature of the reaction solution is then raised considerably to complete the dehydration ring closure. The temperatures used to complete the ring closure are typically from 150° C. to 200° C. A high temperature is used is to assure converting the polyamic acid into a polyimide. Optionally, a co-solvent can be used help remove the water produced during imidization (e.g., toluene, xylene and other aromatic hydrocarbons).

The chemical method includes the use of a chemical imidizing agent, which is used to catalyze the dehydration, or ring closing. Chemical imidization agents such as acetic anhydride and β-picoline can be used. The reaction solvent is not particularly limited so long as it is capable of dissolving the polyamic acid and polyimide. The resulting polyimide is then precipitated. This can be performed by adding the polyimide to a non-solvent. These non-solvents can be methanol, ethanol, or water. The solid is washed several times with the non-solvent, and the precipitate is oven dried.

The present disclosure also comprises a sterically hindered epoxy. While many epoxies are known to be hydrophobic, the present inventors found that only some of these epoxies provide good water resistance of cured, embedded resistors with accelerated aging testing at 85° C. and 85% RH. As used herein, these epoxies can be described as being ‘sterically hindered’. As used herein, ‘sterically hindered’ means a polymer having a molecular structure whereby it is difficult for water (or a water molecule) to chemically associate with the backbone polymer.

The sterically hindered epoxy of the present disclosure can be represented by the general formula:

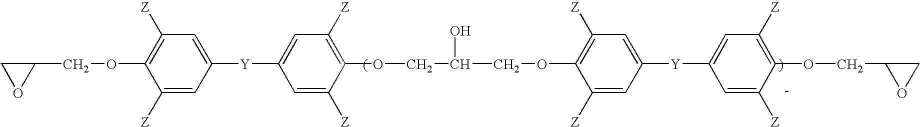

where z is an alkyl, alkoxy, phenyl, phenoxy, halogen, or combinations thereof; where Y is a covalent bond, oxygen, sulfur, methylene, fluorenylidene, ethylidene, sulfonyl, cyclohexylidene, 1-phenylethylidene, C(CH₃)₂, or C(CF₃)₂; and where m is an integer between, and including, 0, 1, 2, 3, 4 and 5. In some embodiments, the epoxy component can be tetramethyl biphenol epoxy (TMBP), tetramethylbisphenol A (TMBPA), tetrabromobisphenol-A epoxy, and mixtures thereof. In some embodiments, the amount of sterically hindered epoxy found to be useful is from 5 to 25 parts by weight of solid, undissolved epoxy.

The composition of the present disclosure comprises a hydrophobic phenolic resin. The hydrophobic phenolic resin is a sterically hindered phenol. For the purpose of this disclosure “hydrophobic phenolic resin” and “sterically hindered phenol” are used interchangeably. The hydrophobic phenolic resin is a thermal crosslinking agent. It is added to the composition of the present disclosure to provide additional crosslinking functionality. In some embodiments, the phenolic resin is present from 5 to 25 parts by weight of solid, undissolved phenolic resin. A highly cross-linked polymer, after a thermal curing cycle, can yield electronic coatings with enhanced thermal and humidity resistance. The effect of thermal crosslinking agent is to stabilize the composition, raise the Tg (glass transition temperature) of the composition, increase chemical resistance, and increase thermal resistance of the cured composition after it is screen printed. In some embodiments, the hydrophobic phenolic resin is a dicyclopentadiene phenolic resin. The addition of the phenolic resin, particularly dicyclopentadiene phenolic resin, improves the hot and cold TCR (thermal coefficient of resistance) values. The addition of a dicyclopentadiene phenolic resin also reduced the resistance change with ESD and with lamination. In some embodiments, the hot TCR values of the compositions of this disclosure are less than 700 ppm/° C. In some embodiments, the hot TCR values of the compositions of this disclosure are less than 628 ppm/° C. In some embodiments, the hot TCR values of the compositions of this disclosure are less than 503 ppm/° C. In some embodiments, the hot TCR values of the compositions of this disclosure are less than 400 ppm/° C. In some embodiments, the hot TCR values of the compositions of this disclosure are less than 200 ppm/° C. In some embodiments, the hot TCR values of the compositions of this disclosure are less than 50 ppm/° C. In some embodiments, the hot TCR values of the compositions of this disclosure are less than 15 ppm/° C. In some embodiments, the cold TCR values of the compositions of this disclosure are less than 200 ppm/° C. In some embodiments, the cold TCR values of the compositions of this disclosure are less than 156 ppm/° C. In some embodiments, the cold TCR values of the compositions of this disclosure are less than 100 ppm/° C. In some embodiments, the cold TCR values of the compositions of this disclosure are less than 61 ppm/° C. In some embodiments, the cold TCR values of the compositions of this disclosure are less than 42 ppm/° C.

In some embodiments, percent resistance change with ESD of compositions of this disclosure is +/−5%. In some embodiments, percent resistance change with ESD of compositions of this disclosure is +/−3%. In some embodiments, percent resistance change with ESD of compositions of this disclosure is +/−1.8%. In some embodiments, percent resistance change with ESD of compositions of this disclosure is +/−0.03%. In some embodiments, percent resistance change with lamination of compositions of this disclosure is +/−5%. In some embodiments, percent resistance change with lamination of compositions of this disclosure is +/−4%. In some embodiments, percent resistance change with lamination of compositions of this disclosure is +/−3.7%. In some embodiments, percent resistance change with lamination of compositions of this disclosure is +/−1.4%.

The present disclosure comprises an organic solvent. In some embodiments, the organic solvent is present from 200 to 900 parts by weight solvent. The organic solvent can easily dissolve the polyimide component and can be boiled off later in processing at a relatively low operating temperature. The polyimide component can typically be in the ‘polyimide state’ (i.e., as opposed to the polymer being in the polyamic acid, or other polyimide precursor state). As such, a lower processing temperature can be achieved (in order to dry the composition of solvent) provided that certain solvents disclosed herein are chosen to allow the composition of the present disclosure to possess sufficient resistance to moisture sorption, particularly during a screen-printing process. In some embodiments, the organic solvent is considered suitable when the polyimide component, in the organic solvent, exhibits a positive solubility measurement. The term, “positive solubility” herein denotes a solution containing 10% solids that is stable in an environment with a relative humidity of about 85% for a period greater than or equal to eight (8) hours at room temperature. The moisture solubility measurement is a test used to measure the solution stability of the composition of the present disclosure in a high moisture environment. The stability of the composition of the present disclosure in high moisture environments is important because processing of the liquid or paste compositions, which involves ingredient mixing, 3 roll milling and screen printing, can take from 2 hours and up to 8 hours. During this time, the polyimide or epoxy generally should not precipitate in the liquid or paste compositions.

In some embodiments, useful solvents include organic liquids having both (i.) a Hanson polar solubility parameter between and including any two of the following numbers 2.1, 2.2, 2.3, 2.4, 2.5, 2.6, 2.7, 2.8, 2.9 and 3.0, and (ii) a normal boiling point ranging from between and including any two of the following numbers 210, 220, 230, 240, 250 and 260° C. In one embodiment, the solvent is selected from one or more dibasic acid esters. In some embodiments, the solvent is selected from, dimethyl succinate, dimethyl glutarate, dimethyl adipate and mixtures thereof. In other embodiments, the solvent is selected from propylene glycol diacetate (PGDA), Dowanol® PPh (1-phenoxy-2-propanol), butyl carbitol acetate, carbitol acetate and mixtures thereof. In some embodiments, cosolvents may be added provided that the composition is still soluble, performance in screen-printing is not adversely affected, and lifetime storage is also not adversely affected.

Another advantage to using the solvents disclosed in the present disclosure is that in certain embodiments, very little, if any, precipitation of the polyimide is observed when handling a paste composition. Also, the use of a polyamic acid solution may be avoided. Instead of using a polyamic acid, which can be thermally imidized to the polyimide later during processing, an already formed polyimide is used. This allows for lower curing temperatures to be used, temperatures not necessary to convert, to near completion, a polyamic acid to a polyimide. In short, the resulting solutions can be directly incorporated into a liquid or paste composition for coating and screen-printing applications without having to cure the polyimide.

In some embodiments, when the organic solvent is removed, the composition has a glass transition temperature greater than 250° C. and a water absorption factor of 2% or less. In some embodiments, when the organic solvent is removed, the composition has a glass transition temperature greater than 280° C. and a water absorption factor of 1% or less. In some embodiments, when the organic solvent is removed, the composition has a glass transition temperature greater than 300° C.

In some embodiments, the composition of the present disclosure may contain an electrically conductive material. In some embodiments, the electrically conductive material is a nanopowder. A nanopowder is intended to mean a microscopic particle with at least one dimension less than 100 nm. In some embodiments, the electrically conductive material has a particle size between and optionally including any two of the following numbers 30, 35, 40, 45, 50, 55, 60, 65, 70, 75, 80, 85, 90, 95, 100, 105, 110, 115, 120, 125, 130 nm. In some embodiments, the electrically conductive material is a metal or metal oxide. In some embodiments, metal oxides include oxides of a metal selected from the group consisting of Ru, Pt, Ir, Sr, La, Nd, Ca, Cu, Bi, Gd, Mo, Nb, Cr and Ti.

The term “metal oxide” can be defined herein as a mixture of one or more metals with an element of Groups IIIA, IVA, VA, VIA or VIIA of the Periodic Table. In particular, the term metal oxides can include metal carbides, metal nitrides, and metal borides, titanium nitride, titanium carbide, zirconium boride, zirconium carbide, tungsten boride and mixtures thereof. In some embodiments, graphite or carbon powders are used. In some embodiments, the electrically conductive material is nano titanium carbide.

In some embodiments, the electrically conductive material is ruthenium oxide or complex metals having ruthenium. In another embodiment, titanium nitride, titanium carbide, zirconium boride, zirconium carbide, tungsten boride and mixtures thereof can be used.

The amount of electrically conductive material added to the composition depends on the end use application. In some embodiments, the electrically conductive material is present in the range between, and including, any two of the following numbers 10, 15, 20, 25, 30, 35, 40, 45, 50, 55, 60, 65, 70, 75 and 80 weight percent of the total dry weight of the composition. Because screen-printing is often the method of choice for PTF resistors, a paste in accordance with the present disclosure must generally remain stable for reasonably long exposures to ambient moisture (i.e., while the paste resides on the screen). If the paste is not stable to moisture absorption, the polyimide component can precipitate making the paste unusable and thereby requiring considerable effort to remove the residual ‘damaged paste’ from the screen. Additionally, excessive water uptake can also cause the paste's viscosity to drift, thus altering the printed resistor thickness and ultimately the cured resistance.

Polyimides in general are insoluble. The few polyimides that are soluble are only soluble in select polar organic solvents. But, many polar organic solvents act like a sponge and absorb water from the ambient environment. Often, the relative humidity of an atmosphere is sufficiently high enough that water absorption into the composition is significant. The water in the composition and in the polyimide solutions can cause the polyimide to precipitate, which essentially renders the composition unusable for most purposes. The composition must be discarded, and the screen may be damaged in attempts to remove intractable paste plugging the holes in the screen.

Compositions of the present disclosure can be used in multiple electronic applications. In some embodiments, the composition can be used as a component in an electronic circuit package. In some embodiments, the composition can be used to produce electronic components such as resistors. In some embodiments, the composition can be used as discrete or planar capacitors, inductors, encapsulants, conductive adhesives, dielectric films and coatings, and electrical and thermal conductors. The compositions of the present disclosure can be applied to a variety of substrate materials to make embedded passive-type resistors or other related planar (either embedded or non-embedded) electronic components. In some embodiments, the composition of the present is screen printed to produce a polymer thick film (PTF) resistor.

A PTF resistor is typically produced by applying the desire paste on a suitable substrate using screen-printing. In some embodiments, the substrate is a conductive substrate. In some embodiments, the substrate is a metal layer or a metal foil. In some embodiments, the substrate is copper. In some embodiments, the substrate is metal alloys, such as copper alloys containing nickel, chromium, iron, and other metals.

Following a drying process, the printed pastes can be cured at relatively low temperatures to remove the solvent. The paste will tend to shrink and compress the conductive particles together, resulting in electrical conductivity between the particles. The electrical resistance of the system tends to depend on the resistance of the materials incorporated into the polymer binder, their particle sizes and loading, as well as the nature of the polymer binder itself.

The electrical resistance of a PTF resistors formed in this fashion is very much dependent on the distances between the electrically conductive particles. The PTF resistors of the present disclosure require physical stability of the polymer binder when exposed to high temperatures and high moisture environments. This is important, so that there is no appreciable or undue change in the electrical resistance of the resistor.

PTF resistor stability can be measured by several known test measurements, including exposing the resistor to environments at 85° C. and 85% relative humidity to show accelerated aging, thermal cycling performance, as well as resistance to the exposure of soldering materials. The high performance PTF resistors using compositions of present disclosure will typically exhibit little, if any, meaningful change in resistance following these tests. PTF materials may also encounter multiple exposures to solder with wave and re-flow solder operations. These thermal excursions are also a source of instability for traditional PTF resistors, particularly when printed directly on copper.

For PTF resistors, the addition of a sterically hindered epoxy according to the present disclosure can improve adhesion to chemically cleaned copper or other metals. This improvement in adhesion can greatly improve the performance of PTF resistors to solder exposure and to accelerated thermal aging. Both thermal cycling, from −25° C. to +125° C., and for 85° C./85% RH thermal cycling performance was significantly improved. The combinations of the polyimides and the epoxies disclosed herein can improve PTF resistors sufficiently that the expensive multi-step immersion silver treatment of a copper (or other metals) may not be necessary.

In many applications the resistor films using the composition of the present disclosure can oftentimes provide a sufficiently stable and reliable interface when bonded directly to a copper trace, simply referred to herein as “non metal-plated copper” (e.g., no silver immersion plating process applied to the copper prior to resistor film application). The omission of the silver-plating process will tend to lower overall cost and complexity in the use of the present disclosure.

Most thick film compositions are applied to a substrate by screen printing, stencil printing, dispensing, doctor-blading into photoimaged or otherwise preformed patterns, or other techniques known to those skilled in the art. These compositions can also be formed by any of the other techniques used in the composites industry including pressing, lamination, extrusion, molding, and the like. However, most thick film compositions are applied to a substrate by means of screen-printing. Therefore, they must have appropriate viscosity so that they can be passed through the screen readily. In addition, they should be thixotropic in order that they set up rapidly after being screened, thereby giving good resolution. Although the rheological properties are of importance, the organic solvent should also provide appropriate wettability of the solids and the substrate, a good drying rate, and film strength sufficient to withstand rough handling.

Curing of a paste composition is accomplished by any number of standard curing methods including convection heating, forced air convection heating, vapor phase condensation heating, conduction heating, infrared heating, induction heating, or other techniques known to those skilled in the art. In one embodiment of the present disclosure, a catalyst can be used to aid in curing of a polymer matrix. Useful catalysts of the present disclosure include, but are not limited to, blocked or unblocked tertiary aromatic amine catalysts. In some embodiments, the catalysts are selected from dimethylbenzylammonium acetate and dimethylbenzylamine.

In some applications the use of a crosslinkable polyimide, or crosslinkable epoxy, in a liquid or paste composition can provide important performance advantages over the corresponding non-crosslinkable polyimide or epoxies of the invention. For example, the ability of the polyimide to crosslink with crosslinking agents during a thermal cure can provide electronic coatings with enhanced thermal and humidity resistance. The resulting cross-linked polyimide can stabilize the binder matrix, raise the Tg, increase chemical resistance, or increase thermal stability of the cured coating compositions. Compared to polyimides that contain no crosslinking functionality, slightly lower Tg of the polyimide or slightly higher moisture absorption of the polyimide can be tolerated.

In one embodiment of the present disclosure, the composition can be combined with other fillers to form different types of electronic materials. For example, fillers for capacitors include, but are not limited to, barium titanate, barium strontium titanate, lead magnesium niobate, and titanium oxide. Fillers for encapsulants include, but are not limited to, talc, fumed silica, silica, fumed aluminum oxide, aluminum oxide, bentonite, calcium carbonate, iron oxide, titanium dioxide, mica and glass. Encapsulant compositions can be unfilled. Fillers for thermally conductive coatings include, but are not limited to barium nitride, aluminum nitride, aluminum oxide coated aluminum nitride, silicon carbide, boron nitride, aluminum oxide, graphite, beryllium oxide, silver, copper, and diamond.

PTF materials have received wide acceptance in commercial products, notably for flexible membrane switches, touch keyboards, automotive parts and telecommunications. In one embodiment of the present disclosure, a resistor (or resistive element) is prepared by printing a PTF composition, or ink, onto a sheet in a pattern. Here, it can be important to have uniform resistance across the sheet (i.e., the resistance of elements on one side of the sheet should be the same as that of elements on the opposite side). Variability in the resistance can significantly reduce yield. The resistive element should be both compositionally and functionally stable. Obviously, one of the most important properties for a resistor is the stability of the resistor over time and under certain environmental stresses. The degree to which the resistance of the PTF resistor changes over time or over the lifetime of the electronic device can be critical to performance. Also, because PTF resistors are subject to lamination of inner layers in a printed circuit board, and to multiple solder exposures, thermal stability is needed. Although some change in resistance can be tolerated, generally the resistance changes need to be less than 5%.

Resistance can change because of a change in the spacing or change in volume of functional fillers, i.e., the resistor materials in the cured PTF resistor. To minimize the degree of volume change, the polyimide, and the epoxy (i.e., the composition of the present disclosure component) should have low water absorption so the cured polyimide based material does not swell when exposed to moisture. Otherwise, the spacing of the resistor particles will change resulting in a change in resistance.

Resistors also need to have little resistance change with temperature in the range of temperatures the electronic device is likely to be subjected. The thermal coefficient of resistance must be low, and a change of less than 200 ppm/° C. is considered very favorable.

The compositions of the present disclosure can be especially suitable for providing polymer thick film (PTF) resistors. The PTF resistors made from the inventive polyimides and corresponding compositions exhibit exceptional resistor properties and are thermally stable even in relatively high moisture environments.

In some embodiments, compositions of the present disclosure can further include one or more metal adhesion promoters. In some embodiments, metal adhesion promoters are selected from the group consisting of polyhydroxyphenylether, polybenzimidazole, polyetherimide, polyamideimide, 2-amino-5-mercaptothiophene, 5-amino-1,3,4-thiodiazole-2-thiol, benzotriazole, 5-chloro-benzotriazole, 1-chloro-benzotriazole, 1-carboxy-benzotriazole, 1-hydroxy-benzotriazole, 2-mercaptobenzoxazole, 1H-1,2,4-triazole-3-thiol, mercaptobenzimidazole and mixtures thereof. Typically, these metal adhesion promoters are dissolved in the polyimide solutions of the present disclosure.

In another embodiment of the present disclosure, the compositions can also be dissolved into a solution and used in integrated circuit chip-scale packaging and wafer-level packaging. These compositions can be used as semiconductor stress buffer, interconnect dielectric, protective overcoat (e.g., scratch protection, passivation, etch mask, etc.), bond pad redistribution, an alignment layer for a liquid crystal display, and solder bump under fills.

### EXAMPLES

The invention will be further described in the following examples, which do not limit the scope of the invention described in the claims.

Processing and test procedures used in preparation of, and testing, of the polyimides of the present disclosure (and compositions containing these polyimides) are described below.

3 Roll Milling

A three-roll mill is used for grinding pastes to fineness of grind (FOG) generally <5μ. The gap is adjusted to 1 mil before beginning. Pastes are typically roll-milled for three passes at 0, 50, 100, 150, 200, 250 psi until FOG is <5μ. Fineness of grind is a measurement of paste particle size. A small sample of the paste is placed at the top (25μ mark) of the grind gauge. Paste is pushed down the length of the grind gauge with a metal squeegee. FOG is reported as x/y, where x is the particle size (microns) where four or more continuous streaks begin on the grind gauge, and y is the average particle size (micron) of the paste.

### Screen-Printing

A 230 or 280 mesh screen and a 70-durometer squeegee are used for screen-printing. Printer is set up so that snap-off distance between screen and the surface of the substrate is typically 35 mils for an 8 in×10 in screen. The downstop (mechanical limit to squeegee travel up and down) is preset to 5 mil. Squeegee speed used is typically 1 in/second, and a print-print mode (two swipes of the squeegee, one forward and one backward) is used. A minimum of 20 specimens (per paste) was printed. After all the substrates for a paste are printed, they are left undisturbed for a minimum of 10 minutes (so that air bubbles can dissipate), then cured 1 hr at 170° C. in a forced draft oven.

### ESD

Samples of cured resistor are exposed to 2,000 volts and the sample is exposed to 10 repetitions. The resistance change (as a resistor) is measured. Resistance in measured by Keithly 2700 Multimeter/Data Acquisition System.

### TCR

TCR (thermal coefficient of resistance) is measured and reported in ppm/° C. for both hot TCR(HTCR) at 125° C. and cold TCR(CTCR) at −40° C. A minimum of 3 specimens for each sample, each containing 8 resistors, is used. The automated TCR averages the results.

The following glossary contains a list of names and abbreviations for each ingredient used:

| | |
|---|---|
| Boron nitride | A 1 micron average particle size BN |
| | from Aldrich Chemical Co. |
| Silicone carbide | 130 grams of SiC from Norton (100 grit |
| | E85 Crystolon ® 5300) was milled 144 |
| | hours in a 1 liter Nylon ® coated mill jar |
| | that was half filled with ⅜ inch zirconia |
| | YTZ media. Enough isopropanol was |
| | added to cover the media and after |
| | milling, the dispersion was separated |
| | from the media, centrifuged and dried to |
| | powder that was seived through a 230 |
| | mesh screen which was analyzed to |
| | have a D50 of 0.39 microns. |
| Polyimide medium 1 | A solution was made of 17.56 wt % pre- |
| | imidized polyimide of EXAMPLE 1, 3.79 wt % |
| | RSS-1407, 1.80 wt % of a 61.3% |
| | solids solution of ESD-1819 in a 1:2 |
| | mixture of DBE-2:DBE-3 and 76.85 wt % |
| | of a 1:2 mixture of DBE-2:DBE-3 |
| Polyimide medium 2 | A solution was made of 19.26 wt % pre- |
| | imidized polyimide of EXAMPLE 1, 3.76 wt % |
| | RSS-1407, and 76.98 wt % of a |
| | 1:2 mixture of DBE-2:DBE-3 |
| R1396 carbon black | A paste was made of 19.98 wt % |
| paste 1 | R1396, 14.04 wt % pre-imidized |
| | polyimide of EXAMPLE 1, 3.03 wt % |
| | RSS-1407, 1.44 wt % Durite ® ESD- |
| | 1819, 61.42 wt % of a 1:2 mixture of |
| | DBE-2:DBE-3 and 0.1 wt % 2- |
| | heptanone. |
| R1396 carbon black | A paste was made of 19.98 wt % |
| paste 2 | R1396, 15.40 wt % pre-imidized |
| | polyimide of EXAMPLE 1, 3.00 wt % |
| | RSS-1407, 61.52 wt % of a 1:2 mixture |
| | of DBE-2:DBE-3 and 0.1 wt % 2- |
| | heptanone. |
| DBE-2 | A solvent from DuPont that is a mixture |
| | of 75% dimethyl glutarate, 24% dimethyl |
| | adipate and 0.3% dimethyl succinate. |
| DBE-3 | A solvent from DuPont that is a mixture |
| | of 10% dimethyl glutarate, 89% dimethyl |
| | adipate and 0.2% dimethyl succinate. |
| Durite ® ESD-1819 | Dicyclopentadiene phenolic resin, |
| | equivalent weight of 250, from Borden |
| | Chemical, Inc. of Louisville, Kentucky. |
| SD-1502 | A low MW bisphenol A-formaldehyde |
| | novolac from Borden Chemical, Inc. of |
| | Louisville, Kentucky. |
| SD-1708 | A relatively high MW phenol- |
| | formaldehyde novolac from Borden |
| | Chemical, Inc. of Louisville, Kentucky. |
| ESD-1817 | A phenol formaldehyde novolac with a |
| | high nitrogen content from Borden |
| | Chemical, Inc. of Louisville, Kentucky. |
| FR4 boards | standard high Tg (170 to 180 degrees |
| | C) glass epoxy circuit boards. |
| R-1396 | Carbon black powder called Vulcan ® |
| | XC-72 from Cabot; 2.20 g/cc |
| RSS-1407 | Epoxy resin based on tetramethyl |
| | biphenyl from Resolution Performance |
| | Products. |
| 2-undecanone | Ketone from Aldrich Chemical Co. |
| Benzotriazole | Adhesion promoter from Aldrich |
| | Chemical Co. |
| Nano TiC 130 nm | Obtained from Aldrich Chemical Co. |
| Nano TiC 30 nm | Obtained from Nanoamor. |
| RuO2 | Powder prepared by DuPont Electronic |
| | Materials. |

Lamination conditions, with a Tetrahedron Press, are 550 psi at a peak temperature of 200 degrees C. for one hour 15 minutes at this peak temperature. Samples are held under vacuum for 15 minutes prior to starting the hot press lamination and at the end of the press cycle the temperature is reduced to 38 degrees C. prior to reducing the pressure.

### Example 1

A polyimide was prepared by conversion of a polyamic acid to polyimide with chemical imidization. To a dry three neck round bottom flask equipped with nitrogen inlet, mechanical stirrer and condenser was added 800.23 grams of anhydrous DMAC, 65.98 grams of 3,3′-bis-(trifluoromethyl)benzidine (TFMB), 18.86 grams 2,2′-bis(3-amino-4-hydroxyphenyl)hexafluoropropane (6F-AP) and 0.764 grams of phthalic anhydride.

To this stirred solution was added over one hour 113.26 grams of 2,2′-bis-3,4-dicarboxyphenyl)hexafluoropropane dianhydride (6-FDA). The solution of polyamic acid reached a temperature of 32° C. and was stirred without heating for 16 hrs. 67.68 grams of acetic anhydride were added followed by 61.73 grams of 3-picoline and the stirred solution was heated to 80° C. for 1 hour.

The solution was cooled to room temperature, and the solution added to an excess of methanol in a blender to precipitate the product polyimide. The solid was collected by filtration and was washed 2 times by re-blending the solid in methanol. The product was dried in a vacuum oven with a nitrogen purge at 150° C. for 16 hrs to yield 187.6 grams of product having a number average molecular weight of 44,300 and a weight average molecular weight of 136,300.

The molecular weight of the polyimide polymer was obtained by size exclusion chromatography using polystyrene standards.

### Example 2

EXAMPLE 2 illustrates the use of a high Tg crosslinkable polyimide used in a PTF resistor composition that contains hydrophobic epoxy and phenolic resins. A PTF resistor paste composition was prepared using the polyimide solution of EXAMPLE 1. This was performed by adding, to the polyimide solution, the additional components listed below, including but not limited to, a hydrophobic epoxy resin, a hydrophobic phenolic resin and electrically conductive materials. The PTF resistor paste composition was prepared by mixing the following ingredients in an ambient environment with stirring to give a crude paste mixture.

| Ingredient | % by weight |
|---|---|
| TiC nano powder 130 nm | 11.69 |
| R1396 carbon black paste 1 | 10.73 |
| Boron nitride powder | 15.47 |
| Silicone carbide powder | 4.57 |
| Polyimide medium 1 | 57.16 |
| Benzotriazole | 0.28 |
| 2-undecanone | 0.9 |

The paste composition was 50.0 percent by weight solids. The PTF resistor paste was 3-roll milled with a 1 mil gap with 3 passes each set at 0, 100 and 200 psi pressure and 6 passes at 300 psi pressure to yield a fineness of grind of 7/2. The paste was screen-printed using a 180-mesh screen, an 80-durometer squeegee, on print-print mode, at 10-psi squeegee pressure, on chemically cleaned FR-4 substrates with a 40 and 60 mil resistor pattern. After screen printing, the samples were baked for 1 hour at 170° C. followed by 2 min at 230° C. using forced draft ovens.

### Example 3

EXAMPLE 3 illustrates the use of a high Tg crosslinkable polyimide used in a PTF resistor composition that contains hydrophobic epoxy and phenolic resins. A PTF resistor paste composition was prepared using the polyimide solution of EXAMPLE 1. This was performed by adding, to the polyimide solution, the additional components listed below, including but not limited to, a hydrophobic epoxy resin, a hydrophobic phenolic resin and electrically conductive materials. The PTF resistor paste composition was prepared by mixing the following ingredients in an ambient environment with stirring to give a crude paste mixture.

| Ingredient | % by weight |
|---|---|
| TiC nano powder 30 nm | 11.69 |
| R1396 carbon black paste 1 | 10.68 |
| Boron nitride powder | 15.46 |
| Silicone carbide powder | 4.62 |
| Polyimide medium 1 | 57.16 |
| Benzotriazole | 0.28 |
| 2-undecanone | 0.11 |

The paste composition was 50.0 percent by weight solids. The paste was screen printed as Example 2.

### Example 4

EXAMPLE 4 illustrates the use of a high Tg crosslinkable polyimide used in a PTF resistor composition that contains hydrophobic epoxy and phenolic resins. A PTF resistor paste composition was prepared using the polyimide solution of EXAMPLE 1. This was performed by adding, to the polyimide solution, the additional components listed below, including but not limited to, a hydrophobic epoxy resin, a hydrophobic phenolic resin and electrically conductive materials. The PTF resistor paste composition was prepared by mixing the following ingredients in an ambient environment with stirring to give a crude paste mixture.

| Ingredient | % by weight |
|---|---|
| RuO2 powder | 11.69 |
| R1396 carbon black paste 1 | 10.68 |
| Talc | 15.46 |
| Polyimide medium 1 | 57.16 |
| Benzotriazole | 0.28 |
| 2-undecanone | 0.11 |

The paste composition was 50.0 percent by weight solids. The paste was screen printed as Example 2.

### Comparative Example 1

COMPARATIVE EXAMPLE 1 illustrates the use of a high Tg crosslinkable polyimide used in a PTF resistor composition that contains hydrophobic epoxy and no phenolic resin. A PTF resistor paste composition was prepared using the polyimide solution of EXAMPLE 1. This was performed by adding, to the polyimide solution, the additional components listed below, including but not limited to, a hydrophobic epoxy resin and electrically conductive materials. The PTF resistor paste composition was prepared by mixing the following ingredients in an ambient environment with stirring to give a crude paste mixture.

| Ingredient | % by weight |
|---|---|
| Titanium carbide nano powder 30 nm | 11.02 |
| R1396 carbon black paste 2 | 10.01 |
| Boron nitride powder | 14.59 |
| Silicone carbide powder | 4.33 |
| Polyimide medium 2 | 59.67 |
| Benzotriazole | 0.28 |
| 2-undecanone | 0.09 |

The paste composition was 47.83 percent by weight solids. The paste was screen printed as Example 2.

### Comparative Example 2

COMPARATIVE EXAMPLE 2 illustrates the use of a high Tg crosslinkable polyimide used in a PTF resistor composition that contains hydrophobic epoxy resin and no phenolic resin. A PTF resistor paste composition was prepared using the polyimide solution of EXAMPLE 1. This was performed by adding, to the polyimide solution, the additional components listed below, including but not limited to a hydrophobic epoxy resin and electrically conductive materials. The PTF resistor paste composition was prepared by mixing the following ingredients in an ambient environment with stirring to give a crude paste mixture.

| Ingredient | % by weight |
|---|---|
| Ruthenium dioxide powder | 23.19 |
| R1396 carbon black paste 2 | 12.41 |
| Talc | 10.69 |
| Polyimide medium 2 | 53.18 |
| Benzotriazole | 0.42 |
| 2-undecanone | 0.11 |

The paste composition was 51.3 percent by weight solids. The paste was screen printed as Example 2.

### Comparative Example 3

COMPARATIVE EXAMPLE 3 illustrates the use of a high Tg crosslinkable polyimide used in a PTF resistor composition that contains hydrophobic epoxy and a different phenolic resin than in EXAMPLE 2. A PTF resistor paste composition was prepared using the polyimide solution of EXAMPLE 1. This was performed by adding, to the polyimide solution, the additional components listed below, including but not limited to, a hydrophobic epoxy resin and electrically conductive materials. The PTF resistor paste composition was prepared by mixing the following ingredients in an ambient environment with stirring to give a crude paste mixture.

| Ingredient | % by weight |
|---|---|
| Titanium carbide nano powder 130 nm | 11.65 |
| R1396 carbon black paste 2 | 10.42 |
| Boron nitride powder | 15.49 |
| Silicone carbide powder | 4.58 |
| Phenolic resin SD-1502 | 1.92 |
| Polyimide medium 2 | 55.55 |
| Benzotriazole | 0.29 |
| 2-undecanone | 0.11 |

The paste composition was 49.76 percent by weight solids. The paste was screen printed as Example 2.

### Comparative Example 4

COMPARATIVE EXAMPLE 4 illustrates the use of a high Tg crosslinkable polyimide used in a PTF resistor composition that contains hydrophobic epoxy resin and a different phenolic resin than in EXAMPLE 2. A PTF resistor paste composition was prepared using the polyimide solution of EXAMPLE 1. This was performed by adding, to the polyimide solution, the additional components listed below, including but not limited to, a hydrophobic epoxy resin and electrically conductive materials. The PTF resistor paste composition was prepared by mixing the following ingredients in an ambient environment with stirring to give a crude paste mixture.

| Ingredient | % by weight |
|---|---|
| Titanium carbide nano powder 130 nm | 11.66 |
| R1396 carbon black paste 2 | 10.36 |
| Boron nitride powder | 15.49 |
| Silicone carbide powder | 4.60 |
| Phenolic resin ESD-1817 | 1.92 |
| Polyimide medium 2 | 55.57 |
| Benzotriazole | 0.30 |
| 2-undecanone | 0.11 |

The paste composition was 49.72 percent by weight solids. The paste was screen printed as Example 2.

### Comparative Example 5

COMPARATIVE EXAMPLE 5 illustrates the use of a high Tg crosslinkable polyimide used in a PTF resistor composition that contains hydrophobic epoxy resin and a different phenolic resin than in EXAMPLE 2. A PTF resistor paste composition was prepared using the polyimide solution of EXAMPLE 1. This was performed by adding, to the polyimide solution, the additional components listed below, including but not limited to a hydrophobic epoxy resin and electrically conductive materials. The PTF resistor paste composition was prepared by mixing the following ingredients in an ambient environment with stirring to give a crude paste mixture.

| Ingredient | % by weight |
|---|---|
| Titanium carbide nano powder 130 nm | 11.69 |
| R1396 carbon black paste 2 | 10.42 |
| Boron nitride powder | 15.49 |
| Silicone carbide powder | 4.60 |
| Phenolic resin SD-1708 | 1.92 |
| Polyimide medium 2 | 55.46 |
| Benzotriazole | 0.31 |
| 2-undecanone | 0.11 |

The paste composition was 49.76 percent by weight solids. The paste was screen printed as Example 2.

The test results for resistance and thermal coefficient of resistance for the Examples and Comparative Examples are listed below. Only the differing electrically conductive material is indicated in the table, since all contain the same carbon black (R1396) as one of the electrically conductive materials.

| | | Resist- | | |
|---|---|---|---|---|
| | | ance | | |
| Electrically | | 60 mil | | |
| conductive | Example or Comparative | resistors | HTCR | CTCR |
| material | Example | (ohm) | (ppm/° C.) | (ppm/° C.) |
| 130 nm TiC | Example 2 | 6,100 | 628 | 156 |
| 30 nm TiC | Example 3 | 5,100 | 503 | 61 |
| RuO₂ | Example 4 | 435 | 15 | 42 |
| 30 nm TiC | Comparative Example 1 | 9,100 | 701 | 110 |
| RuO₂ | Comparative Example 2 | 929 | 16 | −82 |
| 130 nm TiC | Comparative Example 3 | 8,800 | 742 | 279 |
| 130 nm TiC | Comparative Example 4 | 14,200 | 900 | 277 |
| 130 nm TiC | Comparative Example 5 | 8,900 | 793 | 229 |

A surprising result was the lower resistance of Examples 2 to 4 as compared to the Comparative Examples 1-5, which is seen when matching the electrically conductive material between Examples and Comparative Examples. This desirable effect allows the use of less costly electrically conductive material to obtain a target resistance. It was unanticipated that example 2 would have a lower resistance than comparative examples 3, 4 and 5 which have different phenolic resins. This is striking since the same amount of the same conductive materials, TiC and R-1396, were used in each composition. In addition it was non-expected that the use of Durite® ESD-1819 would improve the hot and cold TCR values for example 3 compared to Comparative Example 1, and Example 2 compared to Comparative Examples 3-5. A difference was not anticipated in TCRs when the same weight % of electrically conductive material was used.

Additional differences were obtained when testing the resistors with electrostatic discharge (ESD) with 10 pulses of 2 Kvolts, and when testing the % resistance change of embedded resistors after lamination with prepreg at 200° C. and 550 psi.

| Electrically | | % Resistance | % Resistance |
|---|---|---|---|
| conductive | Example or Comparative | Change with | Change with |
| material | Example | ESD | Lamination |
| 130 nm TiC | Example 2 | −1.6 | −3.7 |
| 30 nm TiC | Example 3 | 0.03 | 1.4 |
| RuO₂ | Example 4 | −1.8 | 1.4 |
| 30 nm TiC | Comparative Example 1 | −1.7 | −3.5 |
| RuO₂ | Comparative Example 2 | −2.5 | −1.1 |
| 130 nm TiC | Comparative Example 3 | −6.3 | −14.6 |
| 130 nm TiC | Comparative Example 4 | −3.0 | 24.7 |
| 130 nm TiC | Comparative Example 5 | −5.0 | −15.7 |

When Durite® ESD-1819 of Example 2 was replaced with the other phenolic resins used in Comparative Examples 3-5, there was a surprisingly large % resistance change with ESD and with lamination. The same electrically conductive material were used for Example 2 and Comparative Examples 3-5. A % resistance change of less than 2% is desired for embedded resistors for ESD, and a % resistance change for the laminates of less than 5% is considered to be necessary for embedded resistor applications.

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

When an amount, concentration, or other value or parameter is given as either a range, preferred range or a list of upper values and lower values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

What is claimed is:

1. A composition comprising:
A. a polyimide having a repeat unit represented by the following formula: 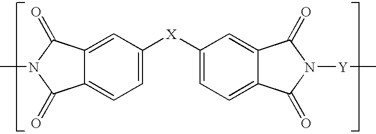
where X is a member of a group consisting of SO₂, C(CF₃)₂, C(CF₃)phenyl, C(CF₃)CF₂CF₃, C(CF₂CF₃)phenyl, and combinations thereof, and
wherein Y is derived from a diamine component, the diamine component comprising from 2 to 50 mole percent of a diamine selected from a group consisting of 2,2′-bis(3-amino-4-hydroxyphenyl)hexafluoropropane (6F-AP), 3,3′-dihydroxy-4,4′-diaminobiphenyl (HAB), 2,4-diaminophenol, 2,3-diaminophenol, 3,3′-diamino-4,4′-dihydroxy-biphenyl, 2,2′-bis(3-amino-3-hydroxyphenyl)hexafluoropropane, and combinations thereof, and
wherein the polyimide is present at 100 parts by weight of solid;
B. a sterically hindered epoxy represented by the following formula: 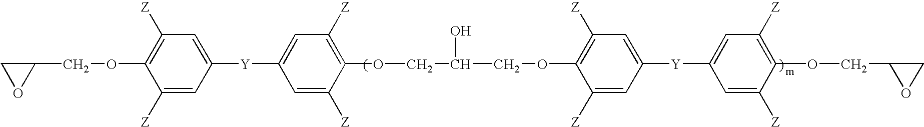
wherein Z is an alkyl, alkoxy, phenyl, phenoxy, halogen, or a combination thereof;
wherein Y is either a covalent bond, oxygen, sulfur, methylene, fluorenylidene, ethylidene, sulfonyl, cyclohexylidene, 1-phenylethylidene, or C(CH₃)₂, C(CF₃)₂; and
wherein m is an integer between and including 0 to 5;
wherein the sterically hindered epoxy is present from 5 to 25 parts by weight of solid;
C. a dicyclopentadiene phenolic resin,
wherein the dicyclopentadiene phenolic resin is present from 5 to 25 parts by weight of solid; and
D. an organic solvent,
wherein the organic solvent is present from 200 to 900 parts by weight solvent.

2. A composition in accordance with claim 1 wherein the sterically hindered epoxy is selected from a group consisting of tetramethyl biphenol epoxy (TMBP), tetramethylbisphenol A epoxy (TMBPA), and tetrabromobisphenol-A epoxy and mixtures thereof.

3. A composition in accordance with claim 1 wherein the diamine component additionally comprising from 50 to 98 mole percent of a diamine selected from a group consisting of 3,4′-diaminodiphenyl ether (3,4′-ODA), 4,4′-diamino-2,2′-bis(trifluoromethyl)biphenyl (TFMB), 3,3′,5,5′-tetramethylbenzidine, 2,3,5,6-tetramethyl-1,4-phenylenediamine, 3,3′-diaminodiphenyl sulfone, 3,3′dimethylbenzidine, 3,3′-bis(trifluoromethyl)benzidine, 2,2′-bis-(p-aminophenyl)hexafluoropropane, bis(trifluoromethoxy)benzidine (TFMOB), 2,2′-bis(pentafluoroethoxy)benzidine (TFEOB), 2,2′-trifluoromethyl-4,4′-oxydianiline (OBABTF), 2-phenyl-2-trifluoromethyl-bis(p-aminophenyl)methane, 2-phenyl-2-trifluoromethyl-bis(m-aminophenyl)methane, 2,2′-bis(2-heptafluoroisopropoxy-tetrafluoroethoxy)benzidine (DFPOB), 2,2-bis(m-aminophenyl)hexafluoropropane (6-FmDA), 2,2-bis(3-amino-4-methylphenyl)hexafluoropropane, 3,6-bis(trifluoromethyl)-1,4-diaminobenzene (2TFMPDA), 1-(3,5-diaminophenyl)-2,2-bis(trifluoromethyl)-3,3,4,4,5,5,5-heptafluoropentane, 3,5-diaminobenzotrifluoride (3,5-DABTF), 3,5-diamino-5-(pentafluoroethyl)benzene, 3,5-diamino-5-(heptafluoropropyl)benzene, 2,2′-dimethylbenzidine (DMBZ), 2,2′,6,6′-tetramethylbenzidine (TMBZ), 3,6-diamino-9,9-bis(trifluoromethyl)xanthene (6FCDAM), 3,6-diamino-9-trifluoromethyl-9-phenylxanthene (3FCDAM), 3,6-diamino-9,9-diphenyl xanthene and mixtures thereof, and
wherein the polyimide is derived from a dianhydride component, the dianhydride component being a dianhydride selected from a group consisting of: 3,3′,4,4′-diphenylsulfone tetracarboxylic dianhydride (DSDA), 2,2-bis(3,4-dicarboxyphenyl)1,1,1,3,3,3-hexafluoropropane dianhydride (6-FDA), 1-phenyl-1,1-bis(3,4-dicarboxyphenyl)-2,2,2-trifluoroethane dianhydride, 1,1,1,3,3,4,4,4-octylfluoro-2,2-bis(3,4-dicarboxyphenyl)butane dianhydride, 1-phenyl-2,2,3,3,3-pentafluoro-1,1-bis(3,4-dicarboxylphenyl)propane dianhydride, 4,4′-oxydiphthalic anhydride (ODPA), 2,2′-bis(3,4-dicarboxyphenyl)propane dianhydride, 2,2′-bis(3,4-dicarboxyphenyl)-2-phenylethane dianhydride, 2,3,6,7-tetracarboxy-9-trifluoromethyl-9-phenylxanthene dianhydride (3FCDA), 2,3,6,7-tetracarboxy-9,9-bis(trifluoromethyl)xanthene dianhydride (6FCDA), 2,3,6,7-tetracarboxy-9-methyl-9-trifluoromethylxanthene dianhydride (MTXDA), 2,3,6,7-tetracarboxy-9-phenyl-9-methylxanthene dianhydride (MPXDA), 2,3,6,7-tetracarboxy-9,9-dimethylxanthene dianhydride (NMXDA) and mixtures thereof.

4. A composition in accordance with claim 1 further comprising an electrically conductive material present in an amount from 10 to 80 weight percent of the total weight of the composition.

5. A composition in accordance with claim 4 wherein the electrically conductive material is an oxide of a metal selected from the group consisting of Ru, Pt, Ir, Cu, Bi, Mo, Nb, Cr and Ti and mixtures thereof.

6. A composition in accordance with claim 4 wherein the electrically conductive material is a material selected from a group consisting of: metal carbides, metal nitrides, metal borides and mixtures thereof.

7. A composition in accordance with claim 4 wherein the electrically conductive material is a nanopowder.

8. A composition in accordance with claim 4 further comprising a non-electrically conductive filler, the filler being selected from a group consisting of talc, fumed silica, silica, fumed aluminum oxide, aluminum oxide, bentonite, calcium carbonate, iron oxide, titanium dioxide, mica, glass and mixtures thereof.

9. A composition in accordance with claim 1, wherein the organic solvent has a Hanson polar solubility parameter from 2.1 to 3.0, and wherein the organic solvent has a normal boiling point from 210 to 260° C.

10. A composition in accordance with claim 1 wherein the organic solvent is selected from one or more dibasic acid esters.

11. A composition in accordance with claim 1 wherein the organic solvent is selected from the group consisting of dimethyl succinate, dimethyl glutarate, dimethyl adipate, propyleneglycol diacetate (PGDA), Dowanol® PPh, butyl carbitol acetate, carbitol acetate and mixtures thereof.

12. A composition in accordance with claim 4 further comprising an adhesion promoter selected from the group consisting of polyhydroxyphenylether, polybenzimidazole, polyetherimide, polyamideimide, PKHH-polyhydroxyphenyl ether, 2-amino-5-mercaptothiophene, 5-amino-1,3,4-thiodiazole-2-thiol, benzotriazole, 5-chloro-benzotriazole, 1-chloro-benzotriazole, 1-carboxy-benzotriazole, 1-hydroxy-benzotriazole, 2-mercaptobenzoxazole, 1H-1,2,4-triazole-3-thiol, mercaptobenzimidazole and mixtures thereof.

13. A composition in accordance with claim 4 further comprising a tertiary aromatic amine catalyst or the salt of a tertiary aromatic amine catalyst.

14. A composition in accordance with claim 4, said composition being in a screen-printed configuration supported directly or indirectly by a layer of copper.
